(19) United States
(12) Patent Application Publication
(10) Pub. No.: US 2026/0049675 A1
(43) Pub. Date: Feb. 19, 2026

(54) ADDITIVELY GROWN KNURL

(71) Applicant: Collins Engine Nozzles, Inc., Des Moines, IA (US)

(72) Inventors: Mark Caples, Ankeny, IA (US); Douglas Westlake, Indianola, IA (US); Jerry Logsdon, Van Meter, IA (US); Jason Clements, West Des Moines, IA (US); Randall D. Siders, Waukee, IA (US); Jacob Douglas Greenfield, Granger, IA (US)

(21) Appl. No.: 18/802,335

(22) Filed: Aug. 13, 2024

(51) Int. Cl. F16L 13/08

(52) U.S. Cl. CPC F16L 13/08

(57) ABSTRACT

A tube joint comprising a first member having a bore defining an inner diameter; a second member having an outer surface configured to be received within the bore; a plurality of protrusions extending from at least one of the bore and the outer surface, wherein the plurality of protrusions being configured to center and retain the second member within the bore of the first member; and a braze joint proximate the plurality of protrusions.

### BACKGROUND

The present disclosure relates to a process for forming parts employed with joining techniques, and more particularly to centering and retaining tube joint members of two concentric parts for fixation such as with or without materials like solder, braze and/or welding.

Joining typically involves fixation of parts to one another, generally inserting a portion of one part into the other part in a press-fitting, welding, soldering, or brazing technique. A press-fitting technique relies on the pressure of abutting surfaces of the parts to form the joint between the parts. Welding generally involves fusing material from either (or both) parts to one another to form a joint between the parts. Soldering and brazing typically involve flowing solder or braze between adjacent surfaces of the parts which, once solidified, forms a joint between the parts.

One challenge to the joining process is centering and retaining the parts. In some assemblies the joining process is accomplished by knurling the surface of the part to be inserted into the other part. Knurling locally deforms the surface of the part such that ridges circumferentially spaced apart from one another by depressions are defined about the part surface. In the case of thin-walled tubular parts fixed by solder or braze, knurling locally thins and thickens the tube wall. Knurling parameters can require careful control to limit the localized thinning and thickening, particularly on thin-walled structures, and radiographic inspection can be necessary to assess coverage.

### SUMMARY

In accordance with the present disclosure, there is provided a tube joint comprising a first member having a bore defining an inner diameter; a second member having an outer surface configured to be received within the bore; a plurality of protrusions extending from at least one of the bore or the outer surface, wherein the plurality of protrusions being configured to center and retain the second member within the bore of the first member; and a braze joint proximate the plurality of protrusions.

A further embodiment of any of the foregoing embodiments may additionally and/or alternatively include the plurality of protrusions comprise an as grown surface finish.

A further embodiment of any of the foregoing embodiments may additionally and/or alternatively include the plurality of protrusions comprise a machined surface finish.

A further embodiment of any of the foregoing embodiments may additionally and/or alternatively include the plurality of protrusions comprise a frangible tip, wherein the frangible tip is configured to deform responsive to contacting at an interface with a mating part such that a portion of the plurality of protrusions deforms or shears during an assembly operation.

A further embodiment of any of the foregoing embodiments may additionally and/or alternatively include the tube joint further comprising a braze stop groove formed in at least one of the first member or the second member proximate the braze joint, wherein the braze stop groove is configured to prevent the flow of braze material.

A further embodiment of any of the foregoing embodiments may additionally and/or alternatively include the tube joint further comprising an as grown surface formed between adjacent protrusions, wherein the as grown surface is formed by additive manufacturing.

A further embodiment of any of the foregoing embodiments may additionally and/or alternatively include the tube joint further comprising a braze material within the braze joint, the braze joint being configured to fix the second member within the bore of the first member.

In accordance with the present disclosure, there is provided a tube joint comprising a first member having a bore defining an inner diameter; a second member having an outer surface configured to be received within the bore; a plurality of protrusions extending from at least one of the bore or the outer surface, wherein the plurality of protrusions being configured to center and retain the second member within the bore of the first member; and a braze joint proximate the plurality of protrusions, the braze joint comprising a braze material within the braze joint, the braze joint being configured to fix the second member within the bore of the first member, wherein at least one of the first member or the second member is formed by additive manufacturing.

A further embodiment of any of the foregoing embodiments may additionally and/or alternatively include the plurality of protrusions comprise an as grown surface finish.

A further embodiment of any of the foregoing embodiments may additionally and/or alternatively include the plurality of protrusions comprise a machined surface finish.

A further embodiment of any of the foregoing embodiments may additionally and/or alternatively include the plurality of protrusions comprise a frangible tip, wherein the frangible tip is configured to deform responsive to contacting at an interface with a mating part such that a portion of the plurality of protrusions deforms or shears during an assembly operation.

A further embodiment of any of the foregoing embodiments may additionally and/or alternatively include the tube joint further comprising an as grown surface formed between adjacent protrusions, wherein the as grown surface is formed by additive manufacturing.

A further embodiment of any of the foregoing embodiments may additionally and/or alternatively include the tube joint further comprising a braze stop groove formed in at least one of the first member or the second member proximate the braze joint, wherein the braze stop groove is configured to prevent the flow of braze material, wherein the braze joint is located between the braze stop groove and the plurality of protrusions.

In accordance with the present disclosure, there is provided a process for forming a tube joint comprising forming by additive manufacturing a first member having a bore defining an inner diameter; forming by additive manufacturing a second member having an outer surface configured to be received within the bore; forming by additive manufacturing a plurality of protrusions extending from at least one of the bore or the outer surface; employing the plurality of protrusions for centering and retaining the second member within the bore of the first member; and forming a braze joint proximate the plurality of protrusions, the braze joint comprising a braze material within the braze joint; and fixing the second member within the bore of the first member.

A further embodiment of any of the foregoing embodiments may additionally and/or alternatively include the process further comprising forming the plurality of protrusions comprising an as grown surface finish.

A further embodiment of any of the foregoing embodiments may additionally and/or alternatively include the process further comprising forming the plurality of protrusions comprising a machined surface finish.

A further embodiment of any of the foregoing embodiments may additionally and/or alternatively include the process further comprising forming the plurality of protrusions comprising a frangible tip; configuring the frangible tip to deform responsive to contacting at an interface with a mating part such that a portion of the plurality of protrusions deforms or shears during an assembly operation.

A further embodiment of any of the foregoing embodiments may additionally and/or alternatively include the process further comprising forming an as grown surface between adjacent protrusions, wherein the as grown surface is formed by additive manufacturing.

A further embodiment of any of the foregoing embodiments may additionally and/or alternatively include the process further comprising forming a braze stop groove in at least one of the first member or the second member proximate the braze joint; configuring the braze stop groove to prevent the flow of braze material; and locating the braze joint between the braze stop groove and the plurality of protrusions.

A further embodiment of any of the foregoing embodiments may additionally and/or alternatively include the process further comprising tailoring the protrusions to include a predetermined quantity of protrusions, a predetermined spacing between protrusions, a predetermined surface area of the protrusions, and a predetermined degree of interference fit of the protrusions.

Other details of the process are set forth in the following detailed description and the accompanying drawings wherein like reference numerals depict like elements.

### BRIEF DESCRIPTION OF THE DRAWINGS

FIG. 1 is a schematic representation of an exploded partially cross-sectional view of an exemplary embodiment of a tube joint constructed in accordance with the present disclosure.

FIG. 2 is a schematic representation of a perspective partially cross-sectional end view of an exemplary embodiment of a tube joint constructed in accordance with the present disclosure.

FIG. 3 is a partial cross-sectional view schematic representation of an exemplary tube joint constructed in accordance with the present disclosure.

FIG. 4 is a partial cross-sectional view schematic representation of an exemplary tube joint constructed in accordance with the present disclosure.

FIG. 5 is a partial cross-sectional view schematic representation of an exemplary tube joint constructed in accordance with the present disclosure.

FIG. 6 is a partial cross-sectional view schematic representation of an exemplary tube joint constructed in accordance with the present disclosure.

FIG. 7 is a side view schematic representation of an exemplary tube joint constructed in accordance with the present disclosure.

FIG. 8 is a partial cross-sectional view schematic representation of an exemplary tube constructed in accordance with the present disclosure.

FIG. 9 is a partial cross-sectional view schematic representation of an exemplary tube joint constructed in accordance with the present disclosure.

FIG. 10 is a partial cross-sectional view schematic representation of an exemplary tube constructed in accordance with the present disclosure.

FIG. 11 is a partial cross-sectional view schematic representation of an exemplary tube joint constructed in accordance with the present disclosure.

FIG. 12 is a partial cross-sectional view schematic representation of an exemplary tube constructed in accordance with the present disclosure.

FIG. 13 is a partial cross-sectional view schematic representation of an exemplary tube joint constructed in accordance with the present disclosure.

FIG. 14 is a partial cross-sectional view schematic representation of an exemplary tube joint constructed in accordance with the present disclosure.

FIG. 15 is a schematic of a variety of shapes for an exemplary knurl protrusion in accordance with the present disclosure.

### DETAILED DESCRIPTION

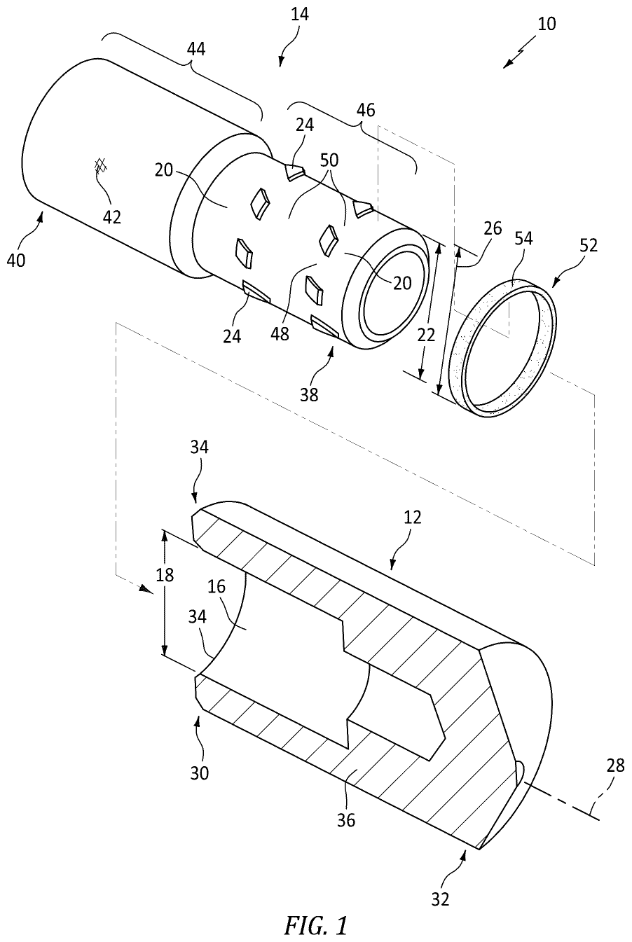

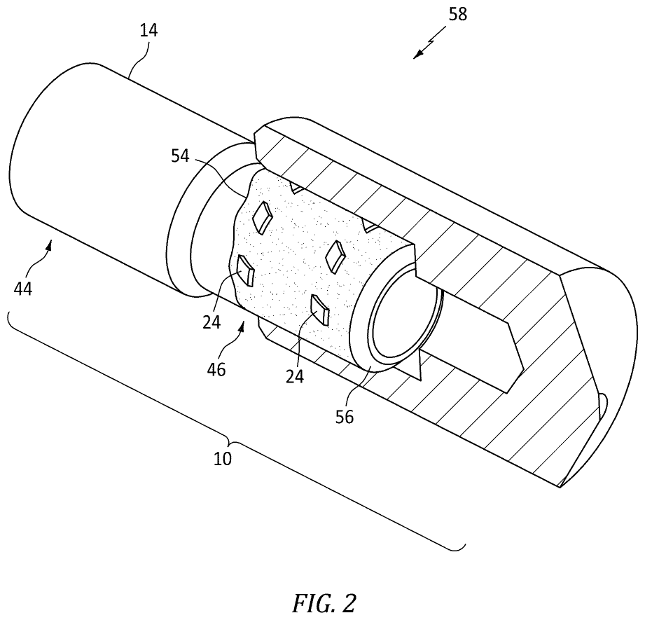

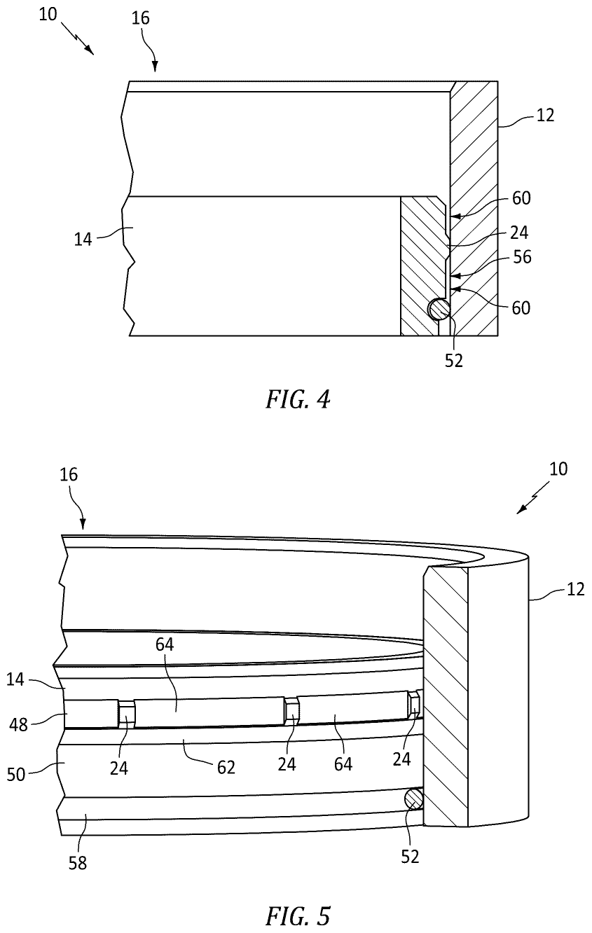

Reference will now be made to the drawings wherein like reference numerals identify similar structural features or aspects of the subject disclosure. For purposes of explanation and illustration, and not limitation, a partial view of an exemplary embodiment of a tube joint in accordance with the disclosure is shown in FIG. 1 and is designated generally by reference character 10. Other embodiments of tube joints, brazed tube joint assemblies, and methods of making brazed tube joints in accordance with the disclosure, or aspects thereof, are provided in FIGS. 2-11, as will be described. The systems and process described herein can be used to make brazed tube joint assembles, like fuel nozzles for gas turbine engines, though the present disclosure is not limited to fuel nozzles or tube joint assemblies in general.

Referring now to FIG. 1 the exemplary tube-in-a-tube joint or simply tube joint 10 is shown. The tube joint 10 can include a first member 12 and a second member 14.

The first member 12 can have a bore 16 defining an inner diameter 18. The second member 14 can have a first outer surface 20 defining a first outer diameter 22 with knurls or protrusions 24 extending radially from the first outer surface 20 beyond the first outer diameter 140. In an exemplary embodiment, there can be two or more protrusions 24. The protrusions 24 collectively define a second outer diameter 26 that is larger than inner/internal diameter 18 of first member 12 by an amount sufficient to center and retain the second member 14 within bore 16 of the first member 12.

The first member 12 defines an axis 28 and has a first end 30 and a second end 32. The first end 30 is open to the external environment through an aperture 34 (in an unassembled state). It is contemplated that first member 12 be constructed of a metallic material 36. The metallic material 36 can include steel, a nickel-based alloy, brass or copper by way of non-limiting examples. Although shown as a blind bore 16, it is to be understood and appreciated that bore 16 can extend through an aperture (not shown) located on the second end 32.

The second member 14 includes a second member first end 38 and a second end 40 and can be formed from a metallic material 42. The metallic material 42 can include steel, a nickel-based alloy, brass or copper by way of non-limiting examples. In the illustrated exemplary embodiment the second member 14 has both a large diameter segment 44 and a small diameter segment 46. The large diameter segment 44 has a diameter that is greater than the internal diameter 18 of the first member 12, is arranged on the second end 40, and is axially adjacent to the small diameter segment 46. Though illustrated as having both a large diameter segment 44 and a small diameter segment 46, it is to be understood and appreciated that the second member 14 can be a singular tube segment having a constant diameter with centering and retention features formed into the constant diameter of the singular tube segment.

Further, although described herein as tube member, it is to be appreciated and understood that non-tubular structures can also benefit from the present disclosure, such as rod-like and non-circular structures.

The protrusions 24, a bottom land surface 48, and circumferential bottom land surfaces 50 can be defined on the small diameter segment 46. The bottom land surfaces 48 are adjacent to circumferentially adjacent protrusions 24. The circumferential bottom land surfaces 50 can be adjacent to protrusions 24. It is contemplated that the bottom land surfaces 48 and circumferential bottom land surfaces 50 can be arranged on a common diameter, e.g., first outer diameter 22. It is also contemplated that first outer diameter 22 and the second outer diameter 26 can be defined by an unknurled surface, such as a surface defined as grown during an additive manufacturing technique. Additive manufacturing is the process of creating an object by building it one layer at a time. It is the opposite of subtractive manufacturing, in which an object is created by cutting away at a solid block of material until the final product is complete. The as grown surface can be created by additive manufacturing and has no need for post processing, or machining or the like. The as grown surface can be considered to be a surface finish following an additive manufacturing process without any further surface finish processes.

The tube joint 10 can be assembled by coupling a braze alloy element 52 to the first end 38 of the second member 14. The braze alloy element 52 can include a braze material 54 selected such that, when molten, braze material 54 flows by capillary action into a gap 56 (FIG. 2) between the second member 14 and the first member 12. In the illustrated exemplary embodiment, the braze alloy element 52 has an annular shape and seats about circumferential bottom land surface 50. It is contemplated that the braze alloy element 52 can alternatively (or additionally) include a braze paste or a braze foil having braze material 34, as suitable for an intended application.

Referring also to FIG. 2, a brazed tube joint assembly 58 is shown in a partially cross-sectional view. The brazed tube joint assembly 58 can include tube joint 10. The tube joint 10 can be formed by the plurality of protrusions 24 defined on small diameter segment 46, which define an interference fit between the first member 12 and the second member 14 and braze material 54. The braze material 54 is disposed between circumferentially adjacent protrusions 24 and fixes the second member 14 within the bore 16 of the first member 12.

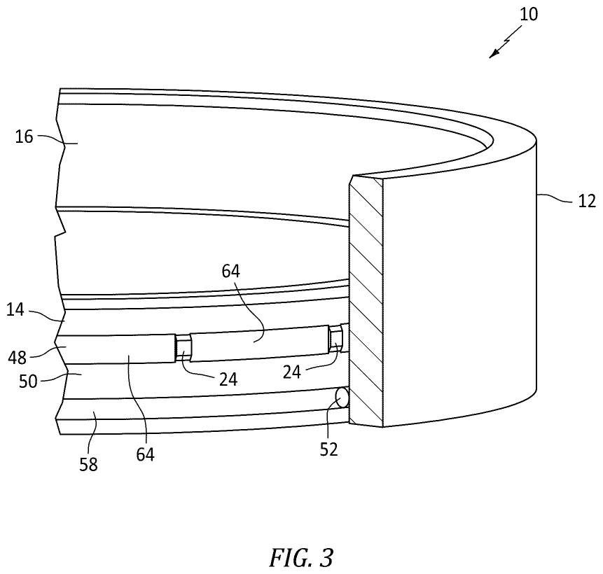

Referring also to FIGS. 3 through 11, the exemplary tube joint 10 is shown. The first member 12 is shown with the second member 14 inserted into the bore 16 of the first member 12. The second member 14 includes the protrusions 24 extending from the bottom land surface 48. The braze alloy element 52 is shown seated in a braze alloy element channel 58 defined in the circumferential bottom land surface 50.

The gap 56 can be employed as a braze joint 60 as the braze material 54 can flow between the protrusions 24 into the gap 56 when the braze material 54 reaches the appropriate temperature. The braze material 54 can flow by capillary action to fill the voids in the gap 56.

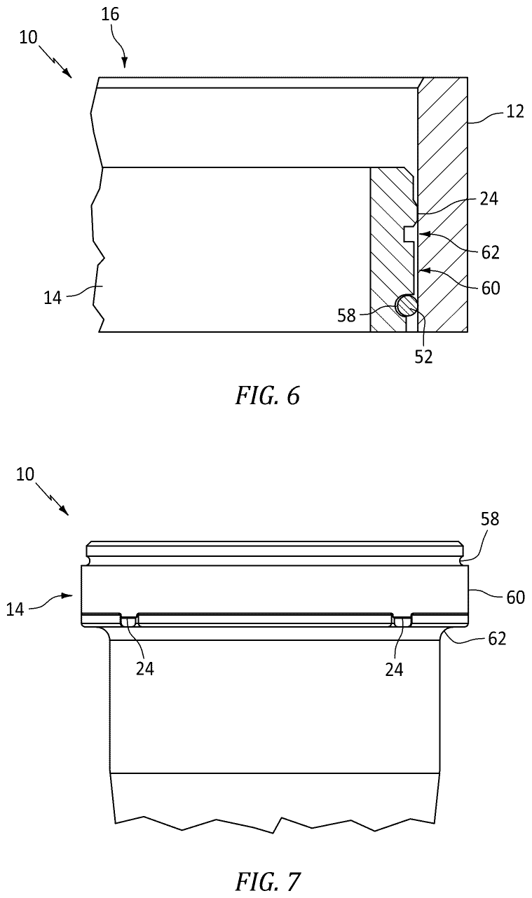

As seen in FIG. 6 the second member 14 can include a braze stop groove 62 formed in the circumferential bottom land surface 50. The braze stop groove 62 can be configured to prevent the braze material 54 from flowing onto the as grown surface 64. By preventing the braze material 54 from the bottom land surface 48, the braze stop groove 62 is configured to keep the alloy of the braze material 54 away from the as grown surface 64.

The diameter of the bottom land surface 48 as grown surface material 64 can be configured to be as close as possible with the diameter of the circumferential bottom land surface 50 proximate the braze joint 60 to provide the optimal volume of braze material 54 in the braze joint 60, (i.e., not too large a gap and not too narrow a gap).

Proximate can be understood to mean relatively near or close, very near or close or at or within a short distance. In an exemplary embodiment, the bottom land surface 48 may not be machined after being grown, while the circumferential bottom land surface 50 can be machined after being grown.

Referring also to FIG. 7, an exemplary embodiment of the second member 14 is shown. The second member 14 after being grown through additive manufacturing techniques, and being machined to predetermined dimensions, is shown with the knurl protrusions 24 located outside the braze joint 60 and proximate the braze stop groove 62. It is contemplated that the knurl protrusions 24 can be tailored to fit the tube joint 10 application. Characteristics of the knurl protrusions 24 that can be tailored can include the quantity of protrusions 24, the spacing between protrusions 24, the surface area of the protrusions 24, and the degree of interference fit of the protrusions 24.

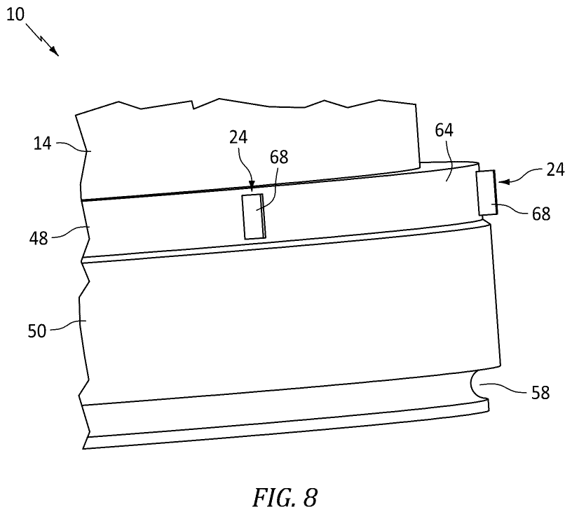

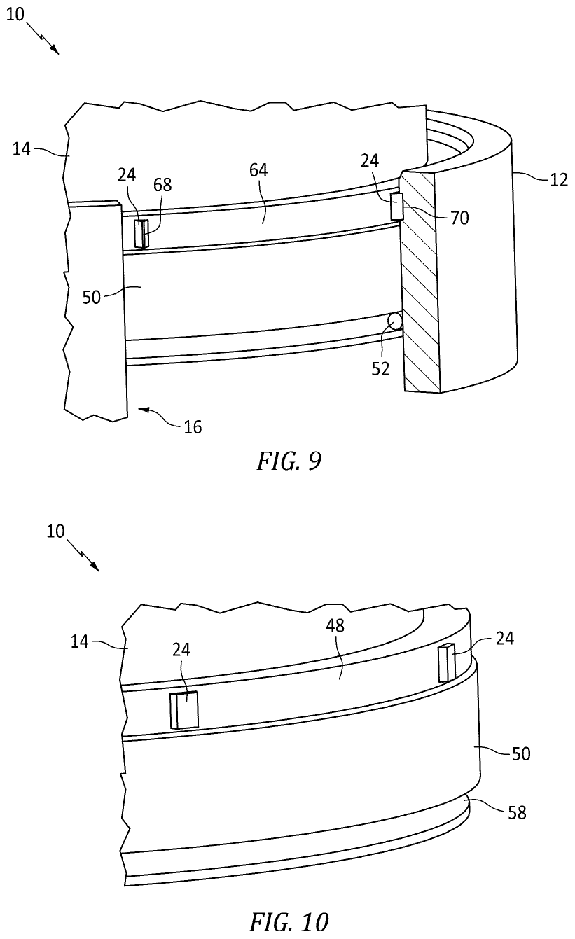

Also referring to FIG. 8 and FIG. 9, the knurl protrusions 24 can be seen shaped with a frangible tip 68. The shape of the protrusion 24 can be tapered such that the frangible tip 68 can deform upon contact with the bore 16 of the first member 12 when forming the tube joint 10. The frangible tip 68 can be part of a protrusion 24 shaped as a pyramid, a triangle cross section either axially oriented or radially oriented. The frangible tip 68 can be formed in an as grown condition, that is, in the absence of machining. Alternatively, the frangible tip 68 can be formed after machining. In this embodiment, the grown knurl protrusions 24 are sufficiently thin or fragile at an interface 70 with the mating part such that a portion of the knurl protrusion 24 deforms or shears during the assembly operation. The remaining portion of each knurl protrusion 24 can provide the required retention and centering functions.

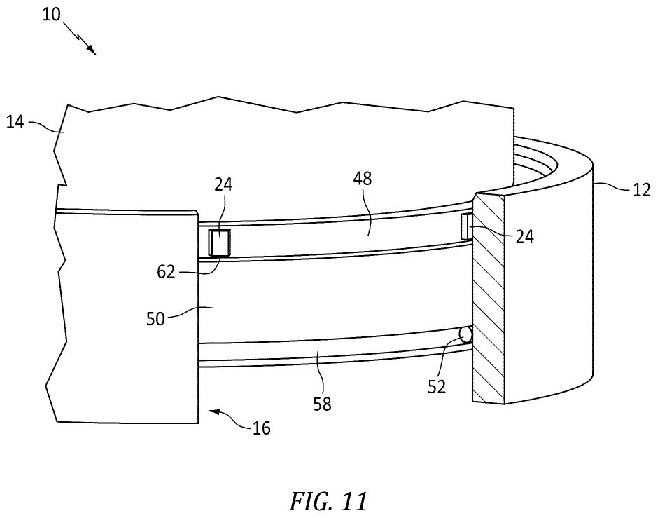

In the exemplary embodiment shown in FIG. 10 and FIG. 11, the protrusions 24 can be seen as grown. The knurl protrusions 24 can be grown to a predetermined dimension that is configured to have an interference fit with the bore 16 of the first member 12. The as grown dimensioning can eliminate the need for post additive manufacturing material removal steps. The knurl protrusions 24 contact the inside diameter of the mating feature with a slight interference fit.

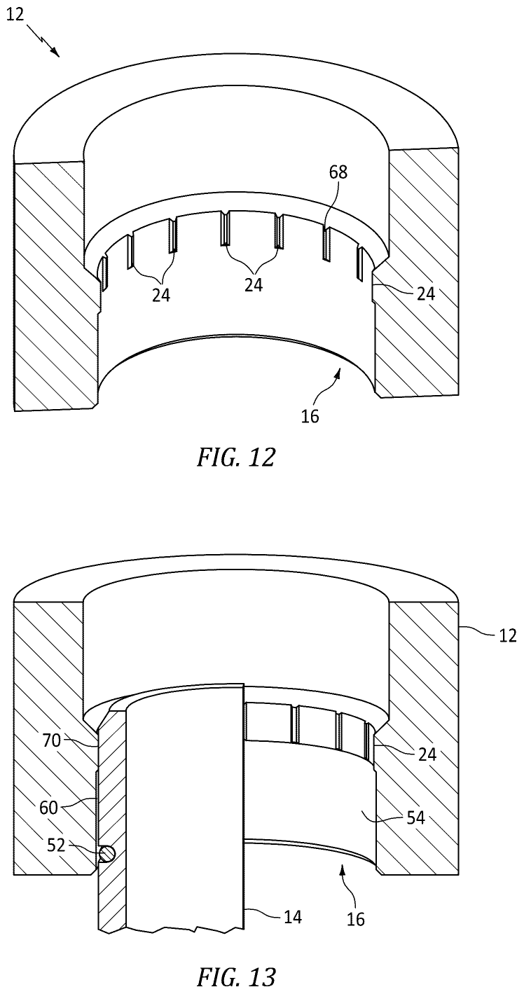

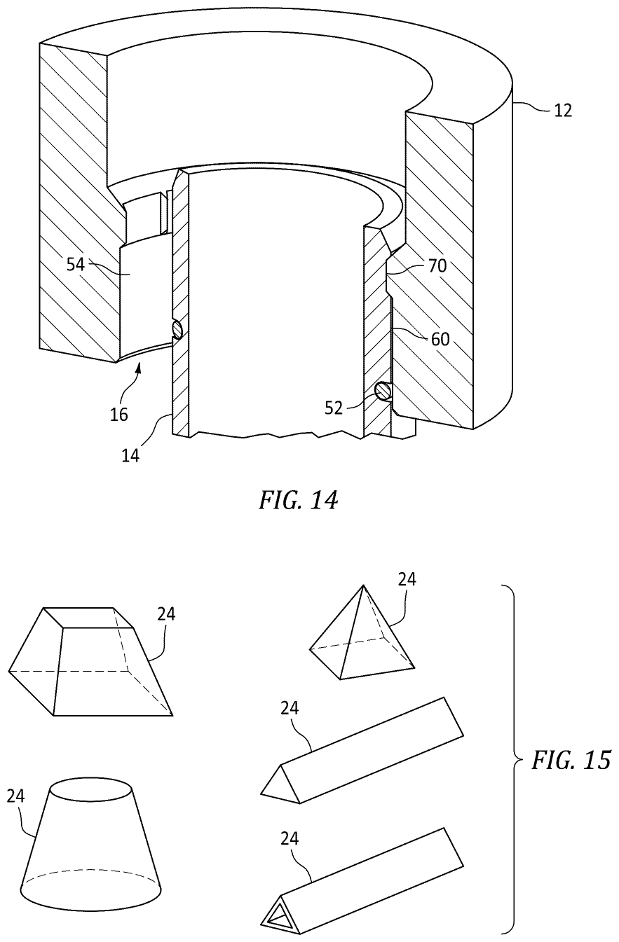

Referring also to FIG. 12, FIG. 13 and FIG. 14, an exemplary first member 12 is shown with protrusions 24 defined within the bore 16. The first member 12 is shown as grown employing additive manufacturing techniques. The as grown first member 12 includes protrusions 24 situated along the bore 16. These protrusions 24 can be configured to a predetermined dimension as grown to create an interference fit with the mating part. The protrusions 24 can be configured with a predetermined dimension extending from the bore 16 surface such that a post machine process can shape the protrusions 24 to have an interference fit with a mating part. The protrusions 24 can be configured to include a frangible tip 68 that can deform upon experiencing the interference fit with the mating part during fit up. The embodiment of FIG. 12 can be employed if a thin wall component such as a heat shield or other tube type component cannot be knurled on the outer surface and is not feasible to make additively on the outside diameter (OD) of a thin wall component such as second member 14, an opposing additively manufactured knurl protrusion 24 can be employed on the bore 16 (inside diameter) of the first member 12 (outer component). The desired knurl protrusion 24 on the bore 16 of the first member 12 (outer component) during the additive build. The knurl protrusions 24 described here still perform the two functions previously mentioned: fixturing and retaining the components 12, 14 and centering the first member 12 and second member 14 for a consistent braze joint 60.

Referring also to FIG. 15, a variety of shapes for the knurl protrusion 24 can be seen. The protrusion 24 can include a pyramid shape an elongated triangular shape, a truncated pyramid shape, a conical shape, a truncated conical shape, triangular in cross section (Triangular Prism), triangular prism turned perpendicular to direction of assembly, a trapezoidal shape, a series of peaks and valleys (waves), hollowed out cross sections for controlling “crush” of the knurl, and the like. These as grown knurl protrusions 24 are configured sufficiently thin or fragile at the interface 70 with the mating part such that a portion of the knurl protrusion 24 deforms or shears during the assembly operation. The remaining portion of each knurl protrusion 24 will provide the required retention and centering functions.

A technical advantage of the disclosed additively grown knurl process includes forming knurls in an as grown geometry to consistently hold parts for a braze joint in the absence of conventionally machining the knurls.

Another technical advantage of the disclosed additively grown knurl process includes controlling the fit up of the knurls to the mating part for consistent press fit by machining the knurls to a tightly controlled diameter.

Another technical advantage of the disclosed additively grown knurl process includes growing the protrusions “oversized” and turning the protrusions to the proper size during the same turning operation that properly creates the braze surface.

Another technical advantage of the disclosed additively grown knurl process includes leaving the knurls as grown to a precise size and shape without any post processing or machining.

Another technical advantage of the disclosed additively grown knurl process includes producing the as grown knurls shaped in a way to allow planned deformation/shear to occur.

There has been provided an additively grown knurl process. While the additively grown knurl process has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A tube joint comprising:
a first member having a bore defining an inner diameter;
a second member having an outer surface configured to be received within the bore;
a plurality of protrusions extending from at least one of the bore or the outer surface, wherein the plurality of protrusions being configured to center and retain the second member within the bore of the first member; and
a braze joint proximate the plurality of protrusions.

2. The tube joint according to claim 1, wherein the plurality of protrusions comprise an as grown surface finish.

3. The tube joint according to claim 1, wherein the plurality of protrusions comprise a machined surface finish.

4. The tube joint according to claim 1, wherein the plurality of protrusions comprise a frangible tip, wherein the frangible tip is configured to deform responsive to contacting at an interface with a mating part such that a portion of the plurality of protrusions deforms or shears during an assembly operation.

5. The tube joint according to claim 1, further comprising:
a braze stop groove formed in at least one of the first member or the second member proximate the braze joint, wherein the braze stop groove is configured to prevent the flow of braze material.

6. The tube joint according to claim 1, further comprising:
an as grown surface formed between adjacent protrusions, wherein the as grown surface is formed by additive manufacturing.

7. The tube joint according to claim 1, further comprising:
a braze material within the braze joint, the braze joint being configured to fix the second member within the bore of the first member.

8. A tube joint comprising:
a first member having a bore defining an inner diameter;
a second member having an outer surface configured to be received within the bore;
a plurality of protrusions extending from at least one of the bore or the outer surface, wherein the plurality of protrusions being configured to center and retain the second member within the bore of the first member; and
a braze joint proximate the plurality of protrusions, the braze joint comprising a braze material within the braze joint, the braze joint being configured to fix the second member within the bore of the first member, wherein at least one of the first member or the second member is formed by additive manufacturing.

9. The tube joint according to claim 8, wherein the plurality of protrusions comprise an as grown surface finish.

10. The tube joint according to claim 8, wherein the plurality of protrusions comprise a machined surface finish.

11. The tube joint according to claim 8, wherein the plurality of protrusions comprise a frangible tip, wherein the frangible tip is configured to deform responsive to contacting at an interface with a mating part such that a portion of the plurality of protrusions deforms or shears during an assembly operation.

12. The tube joint according to claim 8, further comprising:
an as grown surface formed between adjacent protrusions, wherein the as grown surface is formed by additive manufacturing.

13. The tube joint according to claim 8, further comprising:
a braze stop groove formed in at least one of the first member or the second member proximate the braze joint, wherein the braze stop groove is configured to prevent the flow of braze material, wherein the braze joint is located between the braze stop groove and the plurality of protrusions.

14. A process for forming a tube joint comprising:
forming by additive manufacturing a first member having a bore defining an inner diameter;
forming by additive manufacturing a second member having an outer surface configured to be received within the bore;
forming by additive manufacturing a plurality of protrusions extending from at least one of the bore or the outer surface;
employing the plurality of protrusions for centering and retaining the second member within the bore of the first member; and
forming a braze joint proximate the plurality of protrusions, the braze joint comprising a braze material within the braze joint; and
fixing the second member within the bore of the first member.

15. The process of claim 14, further comprising:
forming the plurality of protrusions comprising an as grown surface finish.

16. The process of claim 14, further comprising:
forming the plurality of protrusions comprising a machined surface finish.

17. The process of claim 14, further comprising:
forming the plurality of protrusions comprising a frangible tip;
configuring the frangible tip to deform responsive to contacting at an interface with a mating part such that a portion of the plurality of protrusions deforms or shears during an assembly operation.

18. The process of claim 14, further comprising:
forming an as grown surface between adjacent protrusions, wherein the as grown surface is formed by additive manufacturing.

19. The process of claim 14, further comprising:
forming a braze stop groove in at least one of the first member or the second member proximate the braze joint;
configuring the braze stop groove to prevent the flow of braze material; and
locating the braze joint between the braze stop groove and the plurality of protrusions.

20. The process of claim 14, further comprising:
tailoring the protrusions to include a predetermined quantity of protrusions, a predetermined spacing between protrusions, a predetermined surface area of the protrusions, and a predetermined degree of interference fit of the protrusions.
